(19) United States
(12) Patent Application Publication
(10) Pub. No.: US 2003/0152717 A1
(43) Pub. Date: Aug. 14, 2003

(54) Optical film and liquid crystal display using the same

(76) Inventors: Satoru Kawahara, Osaka (JP); Naoki Takahashi, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/068,910

(22) Filed: Feb. 8, 2002

(51) Int. Cl. C09K 19/00

(52) U.S. Cl. 428/1.31

(57) ABSTRACT

An optical film is disclosed that includes a polarizing plate having a protective layer on at least one side of a polarizer and a brightness-enhanced film laminated to the polarizing plate, such that when the optical film is cut into a 25 mm×150 mm strip-shape and the strip-shaped film is bent at the center of the film so that the both ends in the longitudinal direction of the optical film are allowed to approach each other from above and below and when the distance between the both ends becomes 50 mm, the force applied to the lower part of the film is 0.20 N or less. Advantageously, embodiments of the invention provide an optical film in which less foams enter when the optical film is attached to a liquid crystal cell. As a result, the working operability and yield may be improved. A liquid crystal display using such an optical film is also disclosed.

### BACKGROUND OF THE INVENTION

1. Field of the Invention

The present invention relates to an optical film used for a liquid crystal display (LCD). More specifically, the present invention relates to an optical film having increased elasticity and low flexural rigidity.

2. Description of the Prior Art

Recently, demand for LCDs used for, for example, personal computers has increased sharply. Application for LCDs has also broadened. Recently, such LCDs are used for monitoring as well.

A polarizing plate used for a LCD is manufactured, for example, by a method including steps of: dyeing a polyvinyl alcohol (PVA) film with dichroic iodine or a dichroic dyestuff; crosslinking the film with boric acid, borax, or the like; stretching the film uniaxially, followed by drying the film and sticking it to a protective layer such as a triacetylcellulose (TAC) film. The respective steps of dyeing, crosslinking and stretching are not necessarily carried out separately and can be carried out simultaneously. Furthermore, there is no limitation on the order of the steps.

Recently, optical films used for LCDs have been formed in lamination in order to provide the optical films with a plurality of functions. As the method for lamination, conventional methods have been employed. Examples of conventional methods include a method for laminating an optical film to a dichromatic polarizing plate so as to be integrated; and a method for attaching films having different functions such as a function of widening a viewing angle or a function of enhancing the brightness, etc. via pressure sensitive adhesives or adhesives. Thus, the thickness of the entire film tends to be increased and the rigidity of the entire laminated optical film tends to be increased. As a result, the flexural rigidity of the film is increased, which may be a problem in that foams enter when the optical film is attached to a liquid crystal panel, a problem in working operability at the time of detaching the film from the liquid crystal panel.

### SUMMARY OF THE INVENTION

In one aspect, the present invention relates to a laminated optical film having low flexural rigidity (i.e. a film with low rigidity). In another aspect, the invention relates to a liquid crystal display using such an optical film. In some embodiments, the laminated optical film includes a polarizing plate-integrated brightness-enhanced film in which a brightness-enhanced film is laminated to a conventional dichromatic polarizing plate via a pressure sensitive adhesive to improve the working operability when the optical film is attached or detached to or from the liquid crystal display.

In embodiments of the invention, an optical film includes a polarizing plate having a protective layer on at least one side of a polarizer, and a brightness-enhanced film laminated to the polarizing plate; wherein when the optical film is cut into a 25 mm×150 mm strip-shape and the strip-shaped film is bent at the center of the film so that the both ends in the longitudinal direction of the optical film are allowed to approach each other from above and below and when the distance between the both ends becomes 50 mm, the force applied to the lower part of the film is 0.20 N or less.

Advantages of the invention may include that foams are suppressed from entering and the working operability and yields are improved when the optical film is attached to a liquid crystal cell.

In some embodiments, the brightness-enhanced film comprises a reflecting and polarization separating function.

In some embodiments, the brightness-enhanced film comprises a Granjern structured liquid crystal polymer layer having a circular polarization separating function and a quarter wavelength plate.

In some embodiments, the brightness-enhanced film comprises a linear polarization separating function using reflection at each interface of a multilayer film.

In some embodiments, the polarizing plate and the brightness-enhanced film are laminated via an adhesive layer.

In some embodiments, the liquid crystal polymer layer is formed on a protective layer made of a cellulose-based film.

In some embodiments, the thickness of the protective layer of the polarizing plate and the base material of the brightness-enhanced film is 50 μm or less.

In some embodiments, a retardation film and a viewing angle enlarging film may be laminated to at least one side of the optical film.

In some embodiments, a liquid crystal display uses an optical film in accordance with an embodiment as described above on at least one side of a liquid crystal cell.

### BRIEF DESCRIPTION OF THE DRAWINGS

FIG. 1 is a schematic view which illustrates a method for measuring the flexural rigidity of the optical film.

FIG. 2 is a schematic cross-sectional view showing an optical film according to one embodiment of the present invention.

### DESCRIPTION OF THE PREFERRED EMBODIMENTS

It is possible to reduce the flexural elastic power of laminated optical films as a whole by reducing the flexural rigidity of an individual plastic film used for the laminated optical film. Examples of methods for reducing the flexural rigidity of an individual film include a method of changing the currently used plastic materials into an elastic material; a method for reducing the thickness of a film without changing the material, or the like. By reducing the thickness of a cellulose-based film used as a protective layer and the base material of a brightness-enhanced film, among plastic films used for the conventional dichroic polarizing plates, as compared with the conventional thickness, it is possible to obtain a laminated optical film which is elastic and has low flexural rigidity.

In a basic configuration of a polarizing plate in accordance with the present invention, a transparent protective film as a protective layer is adhered to one side or both sides of a polarizer. The polarizer may be made of a polyvinyl alcohol-based polarizing film containing dichroic substance, and the like. The transparent protective film is attached to the polarizer via an appropriate adhesive layer, for example, a layer of adhesive made of a vinyl alcohol-based polymer.

A polarizer (polarizing film) made of an appropriate vinyl alcohol-polymer film that is known in the art, for example, polyvinyl alcohol film, a partially formalized polyvinyl alcohol film, or the like, is subjected to appropriate treatment such as dyeing with dichroic substances such as iodine and a dichroic dyestuff, stretching, and crosslinking into any suitable orders and manners. Any polarizer can be used, as long as it allows linearly polarized light to pass through the film when natural light enters. In particular, a polarizer with an excellent light transmittance and a polarization degree may be preferred.

As a material for the protective film forming a transparent protective layer provided on one side or both sides of the polarizer (polarizing film), an appropriate transparent film can be used. As the polymer, for example, an acetate-based resin such as triacetylcellulose may be used. However, the polymer is not necessarily limited thereto.

When factors, such as polarizing property and durability are taken into consideration, a preferred transparent protective film may be a triacetylcellulose film having a surface saponified with alkali or the like. A transparent protective film to be provided on one surface of a polarizing film can be a film having surface polymers distinguished from the polymers provided on the other surface of the polarizing film.

In some embodiments, the transparent protective film used for the protective layer may be subject to treatment for providing properties such as hard coating, antireflection, anti-sticking, dispersion, or anti-glaring. Hard coating treatment may be carried out to prevent scratches on the surfaces of the polarizing plate by, for example, applying a surface of the transparent protective film with a coating film of a hardening resin (e.g., a silicon-based ultraviolet hardening resin) having excellent hardness and smoothness, etc.

Anti-reflection treatment may be carried out to prevent reflection of outdoor daylight on the surface of the polarizing plate by, for example, forming an anti-reflection film in a conventional manner. Anti-sticking treatment may be carried out to prevent adjacent layers from sticking to each other. Anti-glaring treatment may be carried out to prevent visibility of light passing through the polarizing plate from being hindered by outdoor daylight reflected on the surface of the polarizing plate. The anti-glaring treatment can be carried out by providing microscopic asperities on a surface of a transparent protective film in an appropriate manner, for example, by roughening the surface by sand-blasting or embossing, by blending transparent particles, or the like.

Examples of the above-mentioned transparent fine particles include silica, alumina, titania, zirconia, stannic oxide, indium oxide, cadmium oxide, antimony oxide or the like, which have an average particle diameter ranging from 0.5 μm to 20 μm. Inorganic fine particles having electroconductivity may also be used. Alternatively, organic fine particles including, for example, crosslinked or uncrosslinked polymer particles, etc. can be used. The amount of the transparent fine particles may range generally from 2 parts by weight to 70 parts by weight, and more particularly from 5 parts by weight to 50 parts by weight for 100 parts by weight of the transparent resin.

An anti-glare layer including transparent fine particles can be provided as the transparent protective layer or a coating layer applied onto the surface of the transparent protective layer. The anti-glare layer may a function as a diffusion layer to diffuse light passing through the polarizing plate to enlarge viewing angle (this function is referred to as a viewing angle compensating function). The above-mentioned layers such as the anti-reflection layer, the anti-sticking layer, the diffusion layer, and the anti-glare layer can be provided separately from the transparent protective layer as an optical layer, for example, in sheet form including the above-mentioned layers.

There is no specific limitation on the treatment for adhering the polarizer (polarizing film) to the transparent protective film that is a protective layer. Adhesion can be carried out, for example, by using an adhesive such as an adhesive including a vinyl alcohol-based polymer, or an adhesive including at least a water-soluble crosslinking agent of vinyl alcohol-based polymer such as boric acid, borax, glutaraldehyde, melamine and oxalic acid. A layer of such an adhesive can be formed by, for example, applying and drying an aqueous solution. In preparation of the aqueous solution, other additives, or a catalyst such as an acid can be blended if necessary.

A polarizer can be used as an optical member that is laminated onto another optical layer. Although there is no specific limitation on the optical layer, one or two or more of appropriate optical layer(s) applicable for formation of a liquid crystal display, etc. can be used. Examples of an optical layer include, for example, a reflector, a transreflector, a retardation plate (such as a λ plate like a half wavelength plate and a quarter wavelength plate), a viewing angle compensating film, a brightness-enhanced film, and the like. Examples of a polarizing plate include a reflective polarizing plate or a semitransparent polarizing plate formed by laminating a reflector or a transreflector on the above-mentioned polarizing plate including a polarizer and a protective layer according to the present invention; an elliptical polarizing plate or a circular polarizing plate formed by laminating a retardation plate on the above-mentioned polarizing plate including a polarizer and a protective layer; a polarizing plate formed by laminating a viewing angle compensating film on the above-mentioned polarizing plate including a polarizer and a protective layer; and a polarizing plate formed by laminating a brightness-enhanced film on the above-mentioned polarizing plate including a polarizer and a protective layer.

A reflector may be provided on a polarizing plate in order to form a reflective polarizing plate. In general, such a reflective polarizing plate is provided on the backside of a liquid crystal cell in order to make a liquid crystal display, etc. to display by reflecting incident light from a visible side (display side). The reflective polarizing plate has some advantages, for example, light sources such as backlight need not be built in, and thus the liquid crystal display can be thinner.

The reflective polarizing plate can be formed in an appropriate manner such as attaching a reflecting layer made of, for example, metal on one surface of the polarizing plate via, for example, the above-mentioned transparent protective film as required. In a specific example, a reflecting layer may be formed by attaching a foil of a reflective metal such as aluminum or a deposition film on one surface of the transparent protective film that has been subjected to matting treatment as required.

Another example of a reflective polarizing plate includes the above-mentioned transparent protective film having a surface of microscopic asperities due to fine particles contained and a reflecting layer corresponding to the microscopic asperities. The reflecting layer having a surface with microscopic asperities diffuses incident light irregularly, so that directivity and glare can be prevented and irregularity in color tones can be controlled. This transparent protective film can be formed by attaching a metal directly onto a surface of a transparent protective film using any appropriate method including deposition such as vacuum deposition, and plating such as ion plating and sputtering.

Furthermore, the reflector can be used as, for example, a reflecting sheet formed by providing a reflecting layer onto an appropriate film similar to the transparent protective film, instead of the above-mentioned method of producing a reflector directly on the transparent protective film of the polarizing plate. The reflecting layer of the reflector, which generally is made of metal, may be preferably used with its surface covered with a film, a polarizing plate or the like, so the reduction of reflectance due to oxidation can be prevented, the initial reflectance can be maintained for a long time, an additional protective layer need not be formed, or the like.

A semitransparent polarizing plate can be obtained by using a method similar to that for forming a reflective polarizing plate as described above, except that a semitransparent reflecting layer such as a half mirror, which reflects light and transmits light, is used instead of the reflecting layer in the above. In general, the semitransparent polarizing plate may be provided on the backside of a liquid crystal cell. When a liquid crystal display is used in a relatively bright atmosphere, the semitransparent polarizing plate allows an incident light from the visible side (display side) to be reflected to display an image, while in a relatively dark atmosphere, an image is displayed by using a built-in light source such as a backlight behind the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

An elliptical polarizing plate or a circular polarizing plate in which a retardation plate is additionally laminated on the above-mentioned polarizing plate including a polarizer and a protective layer will now be explained.

A retardation plate is typically used for modifying linearly polarized light to either elliptical polarized light or circular polarized light, modifying elliptical polarized light or circular polarized light to linearly polarized light, or modifying a polarization direction of linearly polarized light. In particular, a retardation plate called a quarter wavelength plate (λ/4 plate) is generally used for modifying linearly polarized light to circular polarized light, and for modifying circular polarized light to linearly polarized light. A half wavelength plate (λ/2 plate) is generally used for modifying a polarization direction of linearly polarized light.

An elliptical polarizing plate can be effective in compensating (preventing) colors (blue or yellow) generated due to birefringence in a liquid crystal layer of a super twist nematic (STN) liquid crystal display so as to provide a black-and-white display free from the above-mentioned colors. Controlling three-dimensional refractive index may be further preferred since an elliptical polarizing plate can compensate (prevent) colors observed when looking a screen of the liquid crystal display from an oblique direction. A circular polarizing plate is effective, for example, in adjusting color tones of an image of a reflective liquid crystal display that has a color image display, and it also serves to prevent reflection as well.

Examples of a retardation plate include, for example, a birefringent film prepared by stretching an appropriate polymer film, an oriented film of a liquid crystal polymer, and an oriented layer of a liquid crystal polymer that is supported by a film, and the like. Examples of the polymer include, polycarbonate, polyvinyl alcohol, polystyrene, polymethyl methacrylate, polyolefins such as polypropylene, polyalylate, and polyamide. The incline-oriented film may be prepared by, for example, bonding a heat shrinkable film to a polymer film and subjecting the polymer film to stretching treatment and/or shrinking treatment under the influence of a shrinkage force by heat, or by orienting obliquely a liquid crystal polymer.

A polarizing plate in which a viewing angle compensating film is laminated on the above-mentioned polarizing plate including a polarizer and a protective layer will now be explained.

The viewing angle compensating film is typically used for widening a viewing angle so that an image can be seen relatively clearly even when a screen of a liquid crystal display is viewed from a slightly oblique direction.

As the viewing angle compensating film, a triacetylcellulose film etc. coated with a discotic liquid crystal, or a retardation plate may be used. While an ordinary retardation plate is a birefringent polymer film that is stretched uniaxially in the face direction, a retardation plate used as the viewing angle compensating film is a two-way stretched film such as a birefringent polymer film stretched biaxially in the face direction, or an incline-oriented polymer film with a controlled refractive index in the thickness direction that is stretched uniaxially in the face direction and stretched also in the thickness direction. The incline-oriented film is prepared by, for example, bonding a heat shrinkable film to a polymer film and subjecting the polymer film to stretching treatment and/or shrinking treatment under the influence of a shrinkage force by heat, or by obliquely orienting a liquid crystal polymer. A polymer as a material of the retardation plate is similar to the polymer used for the above-mentioned retardation plate.

A polarizing plate in which a brightness-enhanced film is attached to the above-mentioned polarizing plate including a polarizer and a protective layer is generally arranged on the backside of a liquid crystal cell. When natural light enters by the backlight of the liquid crystal display etc. and reflection from the backside and the like, the brightness-enhanced film reflects linearly polarized light of a predetermined polarizing axis or circularly polarized light in a predetermined direction, while transmitting other light. The polarizing plate in which the brightness-enhanced film is laminated on the above-mentioned polarizing plate including a polarizer and a protective layer allows entrance of light from a light source such as a backlight to obtain transmitted light in a predetermined polarization state, while reflecting light other than light in the predetermined polarization state. Light reflecting by the brightness-enhanced film is reversed through a reflecting layer or the like arranged additionally behind the brightness-enhanced film. The reversed light is allowed to re-enter the brightness-enhanced plate. The re-entering light is transmitted partly or entirely as light in a predetermined polarization state so as to increase the amount of light passing through the brightness-enhanced film and polarized light that is hardly absorbed in the polarizer is supplied so as to increase the amount of light available for the liquid crystal display, etc. Thus, the brightness can be enhanced. When light enters through a polarizer from the backside of the liquid crystal cell by using a backlight or the like without using any brightness-enhanced films, most of the light having a polarization direction inconsistent with the polarization axis of the polarizer is absorbed in the polarizer but not transmitted by the polarizer. Depending on the characteristics of the polarizer, about 50% of light is absorbed in the polarizer, which decreases the quantity of light available in the liquid crystal display or the like and makes the image dark. The brightness-enhanced film repeatedly prevents light having a polarization direction to be absorbed in the polarizer from entering the polarizer to reflect the light on the brightness-enhanced film, and reverses the light through a reflecting layer or the like provided behind the brightness-enhanced film to make the light re-enter the brightness-enhanced plate. Since the brightness-enhanced film transmits the polarized light that is reflected and reversed between the brightness-enhanced film and the reflecting layer only if the polarized light has a polarization direction to pass the polarizer, light from a backlight or the like can be used efficiently for displaying images of a liquid crystal display in order to provide a bright screen.

Examples of a brightness-enhanced film include, for example, a film which transmits a linearly polarized light having a predetermined polarization axis and reflects other light, for example, a multilayer thin film of a dielectric or a multilayer laminate of thin films with varied refraction aeolotropy; a film that reflects either clockwise or counterclockwise circular polarized light while transmitting other light, for example, a cholesteric liquid crystal layer, more specifically, an oriented film of a cholesteric liquid crystal polymer or an oriented liquid crystal layer supported on a supportive substrate, or the like.

Therefore, with the brightness-enhanced film transmitting a linearly polarized light having a predetermined polarization axis, the transmitted light directly enters the polarizing plate with the polarization axes matched, so that absorption loss due to the polarizing plate is controlled and the light can be transmitted efficiently. On the other hand, with the brightness-enhanced film transmitting a circular polarized light, such as a cholesteric liquid crystal layer, preferably, the transmission circular polarized light is converted to linearly polarized light before entering the polarizing plate in an aspect of controlling of the absorption loss, although the circular polarized light can enter the polarizer directly. Circular polarized light can be converted to linearly polarized light by using a quarter wavelength plate as a retardation plate.

A retardation plate having a function as a quarter wavelength plate in a wide wave range of a visible light region can be obtained, for example, by overlapping a retardation layer functioning as a quarter wavelength plate for monochromatic light, such as light having 550 nm wavelength, and another retardation plate showing a separate optical retardation property, for example, a retardation plate functioning as a half wavelength plate. Therefore, a retardation plate arranged between a polarizing plate and a brightness-enhanced film can include a single layer or at least two layers of retardation layers.

A cholesteric liquid crystal layer also can be provided by combining layers different in the reflection wavelength and it can be configured by overlapping two or at least three layers. As a result, the obtained retardation plate can reflect circular polarized light in a wide wavelength region of a visible light region, thus providing transmission circular polarized light in a wide wavelength region.

Alternatively, a polarizing plate can be formed by laminating a polarizing plate and two or at least three optical layers like the above-mentioned polarization separating type polarizing plate. In other words, the polarizing plate can be a reflective elliptical polarizing plate, a semitransparent elliptical polarizing plate or the like, which is prepared by combining the above-mentioned reflective polarizing plate or a semitransparent polarizing plate with a retardation plate. An optical member including a lamination of two or at least three optical layers can be formed in a method of laminating layers separately in a certain order for manufacturing a liquid crystal display etc. or in a method for preliminary lamination. Because an optical member that has been laminated previously has excellent stability in quality and assembling operability, efficiency in manufacturing a liquid crystal display can be improved. Any appropriate adhesion means, such as a pressure sensitive adhesive layer, can be used for lamination.

The pressure sensitive adhesive layer can be provided on a polarizing plate or on an optical member for adhesion with other members such as a liquid crystal cell. The adhesive layer can be formed by the conventional appropriate pressure sensitive adhesives such as an acrylic pressure sensitive adhesive. Pressure sensitive adhesives having a low moisture absorption coefficient and an excellent heat resistance may be preferred due to aspects of prevention of foaming or peeling caused by moisture absorption, prevention of decrease in the optical properties and warping of a liquid crystal cell caused by difference in thermal expansion coefficients, formation of a high quality liquid crystal display having excellent durability, etc. The pressure sensitive adhesive layer can contain fine particles to obtain optical diffusivity. Pressure sensitive adhesive layers can be provided on necessary surfaces if required. For example, the polarizing plate including a polarizer and a protective layer can be provided with a pressure sensitive adhesive layer on at least one surface of the protective layer as required.

When a pressure sensitive adhesive layer provided on the polarizing plate or the optical member is exposed on the surface, preferably, the pressure sensitive adhesive layer is temporarily covered with a separator for preventing contamination by the time the pressure sensitive adhesive layer is used. The separator can be made of an appropriate thin sheet by coating a peeling agent if required. Examples of a peeling agent include, for example, a silicone-based peeling agent, a long-chain alkyl-based peeling agent, a fluorine-based peeling agent, a peeling agent including molybdenum sulfide or the like.

The above-described members forming a polarizing plate and an optical member, such as a polarizing film, a transparent protective film, an optical layer, and a pressure sensitive adhesive layer can have ultraviolet absorption power by treating with an ultraviolet absorber such as, for example, an ester salicylate compound, a benzophenone compound, a benzotriazole compound, a cyanoacrylate compound, a nickel complex salt compound, or the like.

The above-mentioned polarizing plate can be used for forming various apparatus such as a liquid crystal display. The liquid crystal display can be produced as conventionally known structures, such as transmission type, reflection type, or a transmission-reflection type. A liquid crystal cell forming the liquid crystal display can be selected arbitrarily from appropriate cells such as active matrix driving type represented by a thin film transistor, a simple matrix driving type represented by a twist nematic type and a super twist nematic type.

When polarizing plates or optical members are provided on both sides of a liquid crystal cell, the polarizing plates or the optical members on both sides can be the same or different. Moreover, for forming a liquid crystal display, one or at least two layers of appropriate members such as a prism array sheet, a lens array sheet, an optical diffuser, or a backlight can be arranged at appropriate positions.

Hereinafter, the present invention will be explained more specifically with reference to Examples and Comparative Examples.

### EXAMPLE 1

As shown in FIG. 2, a polarizing plate 10 was prepared by attaching 40 μm-thick TAC films as protective layers 2 onto the both surfaces of a polarizer 3 made of a 30 μm-thick PVA film containing iodine; and a polarization separating layer 12 including a cholesteric liquid crystal layer 6 having a 40 μm-thick TAC film as a base material 7 and a quarter wavelength plate 5 was prepared, respectively. The polarizing plate 10 and the polarization separating layer 12 were laminated via an adhesive layer 4, to thus form a 300 μm-thick optical film 14 of Example 1 according to the present invention.

In FIG. 2, reference numeral 1 denotes a pressure sensitive adhesive layer.

### EXAMPLE 2

As in Example 1, a polarizing plate was prepared by attaching 50 μm-thick TAC films as protective layers onto the both sides of a polarizer made of a 30 μm PVA film containing iodine, and a polarization separating layer including a cholesteric liquid crystal layer having a 40 μm-thick TAC film as a base material and a quarter wavelength plate was prepared, respectively. The polarizing plate and the polarization separating layer were laminated via an adhesive layer, to thus form a 320 μm-thick optical film of Example 2 according to the present invention.

### COMPARATIVE EXAMPLE 1

As in Example 1, a polarizing plate was prepared by attaching 80 μm-thick TAC films as protective layers onto the both sides of a polarizer made of a 30 μm-thick PVA film containing iodine, and a polarization separating layer including a cholesteric liquid crystal layer having a 80 μm-thick TAC film as a base material and a quarter wavelength plate was prepared, respectively. The polarizing plate and the polarization separating layer were laminated via an adhesive layer, to thus form a 425 μm-thick optical film of Comparative Example 1.

### COMPARATIVE EXAMPLE 2

As in Example 1, a polarizing plate was prepared by attaching 80 μm-thick TAC films as protective layers onto the both sides of a polarizer made of a 30 μm-thick PVA film containing iodine, and a polarization separating layer including a cholesteric liquid crystal layer having a 80 μm-thick TAC film as a base material and a quarter wavelength plate was prepared, respectively. The polarizing plate and the polarization separating layer were laminated via an adhesive layer, to thus form a 380 μm-thick optical film of Comparative Example 2.

### COMPARATIVE EXAMPLE 3

As in Example 1, a polarizing plate was prepared by attaching 80 μm-thick TAC films as protective layers onto the both sides of a polarizer made of a 30 μm-thick PVA film containing iodine, and a viewing angle compensation layer including a discotic liquid crystal layer having a 102 μm-thick TAC film as a base material was prepared, respectively. The polarizing plate and the viewing angle compensating layer were laminated via an adhesive layer, to thus form a 340 μm-thick optical film of Comparative Example 3.

(Method for Measuring Flexural Rigidity of Film)

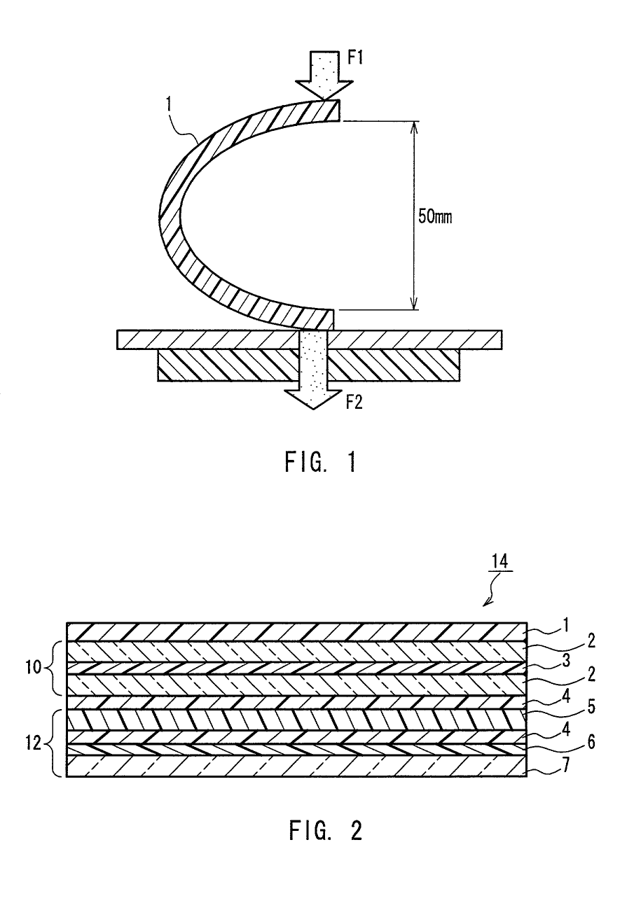

The flexural rigidity of each optical film, which was produced in the above-mentioned Examples and Comparative Examples, was measured. The measurement was carried out as follows: as shown in FIG. 1, each optical film 1 was cut into a 25 mm×150 mm strip-shape and this strip-shaped film 1 was bent at the center of the film with the both ends in the longitudinal direction of the film 1 allowed to approach each other from above and below. When the distance between the both ends becomes 50 mm, the force F2 applied to the lower portion of the film was measured. With this method, it is possible to measure the flexural rigidity of the film 1. The results are shown in Table 1.

As is apparent from Table 1, the flexural rigidity of any of the optical films of the present invention is 0.2 N or less.

TABLE 1

| | | Flexural rigidity | Attachability to |
|---|---|---|---|
| | Film thickness | of film | liquid crystal cell |
| Example 1 | 300 μm | 0.163 N | ◯ |
| Example 2 | 320 μm | 0.193 N | ◯ |
| Co. Example 1 | 425 μm | 0.445 N | X |
| Co. Example 2 | 380 μm | 0.311 N | Δ |
| Co. Example 3 | 340 μm | 0.262 N | Δ |

Co. Example = Comparative Example

(Evaluation of Attachability of Optical Film to Liquid Crystal Cell)

Next, the working operability (attachability) of the above-mentioned optical films with respect to a liquid crystal cell was evaluated. The attachability of the optical films to the liquid crystal cell was evaluated by whether foams enter or not when each optical film is attached to glass. The results are shown in Table 1. In Table 1, the evaluations are carried out as follows: ◯: foams were hardly observed denotes is given; Δ: foams were observed; and ×: foams were significantly observed.

As is apparent from Table 1, in the polarizing plate using an optical film in accordance with the present invention, foams hardly enter, and thus the working operability of attaching the optical film to the liquid crystal cell is improved significantly.

As explained above, by using an optical film in accordance with the present invention, it may be possible to suppress foams from entering when the optical film is attached to the liquid crystal cell, thus improving the working operability and the yield. Thus, an optical film in accordance with the present invention may provide excellent industrial value.

The invention may be embodied in other forms without departing from the spirit or essential characteristics thereof. The embodiments disclosed in this application are to be considered in all respects as illustrative and not limitative. The scope of the invention is indicated by the appended claims rather than by the foregoing description, and all changes which come within the meaning and range of equivalency of the claims are intended to be embraced therein.

What is claimed is:

1. An optical film comprising:
a polarizing plate having a protective layer on at least one side of a polarizer; and
a brightness-enhanced film laminated to the polarizing plate, wherein when the optical film is cut into a 25 mm×150 mm strip-shape and the strip-shaped film is bent at a center of the film so that both ends in a longitudinal direction of the optical film approach each other and the distance between the both ends is 50 mm, the force applied to one end of the film is 0.20 N or less.

2. The optical film according to claim 1, wherein the brightness-enhanced film comprises a reflecting and a polarization separating function.

3. The optical film according to claim 1, wherein the brightness-enhanced film comprises a Granjern structured liquid crystal polymer layer having a circular polarization separating function and a quarter wavelength plate.

4. The optical film according to claim 1, wherein the brightness-enhanced film comprises a linear polarization separating function using reflection at each interface of a multilayer film.

5. The optical film according to claim 1, wherein the polarizing plate and the brightness-enhanced film are laminated by an adhesive layer.

6. The optical film according to claim 3, wherein the liquid crystal polymer layer is disposed on a protective layer made of a cellulose-based film.

7. The optical film according to claim 1, wherein the thickness of the protective layer of the polarizing plate and a base material of the brightness-enhanced film is 50 μm or less.

8. The optical film according to claim 1, further comprising a retardation film and a viewing angle enlarging film laminated to at least one side of the optical film.

9. A liquid crystal display comprising: a liquid crystal cell; an optical film on at least one side of the liquid crystal cell, the optical film comprising: a polarizing plate having a protective layer on at least one side of a polarizer; and
a brightness-enhanced film laminated to the polarizing plate, wherein when the optical film is cut into a 25 mm×150 mm strip-shape and the strip-shaped film is bent at a center of the film so that both ends in a longitudinal direction of the optical film are allowed to approach each other and the distance between the both ends becomes 50 mm, the force applied to one end of the film is 0.20 N or less.

10. The liquid crystal display according to claim 9, wherein the brightness-enhanced film comprises a reflecting and a polarization separating function.

11. The liquid crystal display according to claim 9, wherein the brightness-enhanced film comprises a Granjern structured liquid crystal polymer layer having a circular polarization separating function and a quarter wavelength plate.

12. The liquid crystal display according to claim 9, wherein the brightness-enhanced film comprises a linear polarization separating function using reflection at each interface of a multilayer film.

13. The liquid crystal display according to claim 9, wherein the polarizing plate and the brightness-enhanced film are laminated by an adhesive layer.

14. The liquid crystal display according to claim 11, wherein the liquid crystal polymer layer is disposed on a protective layer made of a cellulose-based film.

15. The liquid crystal display according to claim 9, wherein the thickness of the protective layer of the polarizing plate and a base material of the brightness-enhanced film is 50 μm or less.

16. The liquid crystal display according to claim 9, wherein a retardation film and a viewing angle enlarging film are laminated to at least one side of the optical film.
